(19) United States
(12) Patent Application Publication
(10) Pub. No.: US 2016/0371617 A1
(43) Pub. Date: Dec. 22, 2016

(54) TECHNICAL ARCHITECTURE ASSESSMENT SYSTEM

(71) Applicant: Bank of America Corporation, Charlotte, NC (US)

(72) Inventors: Melissa S. Mullaney, Gastonia, NC (US); Vidya Srikanth, Santa Clara, CA (US); Ananthakrishnan Ravi Venkataraman, Dallas, TX (US); Rajat Wadhwani, Closter, NY (US); John Joseph Towey, Princeton, NJ (US)

(21) Appl. No.: 14/746,100

(22) Filed: Jun. 22, 2015

(51) Int. Cl. G06Q 10/06

(52) U.S. Cl. CPC G06Q 10/0635

(57) ABSTRACT

A technical architecture system comprises a memory, an interface, and a processor. The system stores a plurality of risk areas, receives a request to send data to a third-party entity and retrieves architecture information associated with an architecture of the third-party entity. The architecture information corresponds to at least one of the plurality of risk areas. The system also determines a risk rating of the architecture for at least one of the plurality of risk areas. The risk rating is based on the architecture information. The system may further determine a weight based on the at least one of the plurality of risk areas and determine an area score based on the risk rating and the weight. Finally, the system determines whether to grant permission to send the data to the third-party entity based at least in part on the area score.

### TECHNICAL FIELD

The present invention relates generally to the field of hardware and software development and more particularly to a technical architecture assessment system.

### BACKGROUND

In large enterprise businesses, such as a financial institution, it is imperative that confidential and/or proprietary data be properly protected against exposure. In the financial institution environment, this includes customer data, such as social security numbers, names, addresses, telephone numbers, as well as account related data, such as account numbers, account balances, and transaction entities.

### SUMMARY OF EXAMPLE EMBODIMENTS

According to embodiments of the present disclosure, disadvantages and problems associated with technological assessments may be reduced or eliminated.

In certain embodiments, a system comprises a memory, an interface, and a processor. The system stores a plurality of risk areas, receives a request to send data to a third-party entity and retrieves architecture information associated with an architecture of the third-party entity. The architecture information corresponds to at least one of the plurality of risk areas. The system also determines a risk rating of the architecture for at least one of the plurality of risk areas. The risk rating is based on the architecture information. The system may further determine a weight based on the at least one of the plurality of risk areas and determine an area score based on the risk rating and the weight. Finally, the system determines whether to grant permission to send the data to the third-party entity based at least in part on the area score.

Certain embodiments of the present disclosure may provide one or more technical advantages. In certain embodiments, a system for technical architecture assessment is operable to determine whether a third-party entity has an architecture that provides information security. This reduces or eliminates the risk that confidential customer data is accessed without permission while being sent to and/or stored on an architecture of a third-party entity. In some embodiments, the technical architecture assessment system determines remediation items that, if performed, may result in a grant of permission to send confidential data to a third-party entity. This technique provides alternative solutions to a simple “accept” or “reject” system, thus conserving bandwidth and memory that would be consumed by re-running the architecture assessment each instance a change is made to the architecture of third-party entity.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates an example system that facilitates technical architecture assessment; and

FIG. 2 illustrates an example flowchart for facilitating technical architecture assessment.

### DETAILED DESCRIPTION

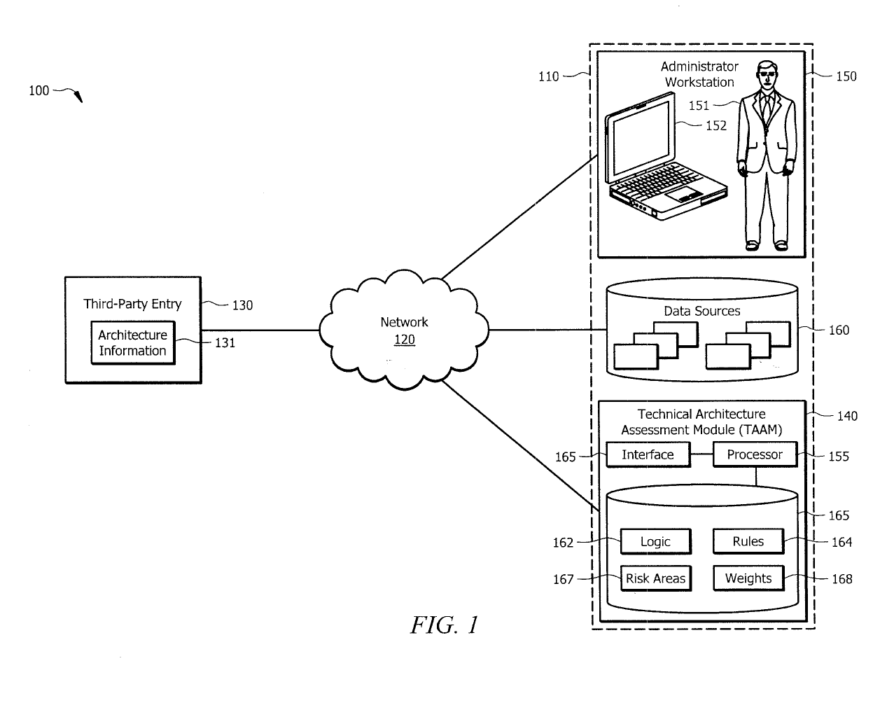

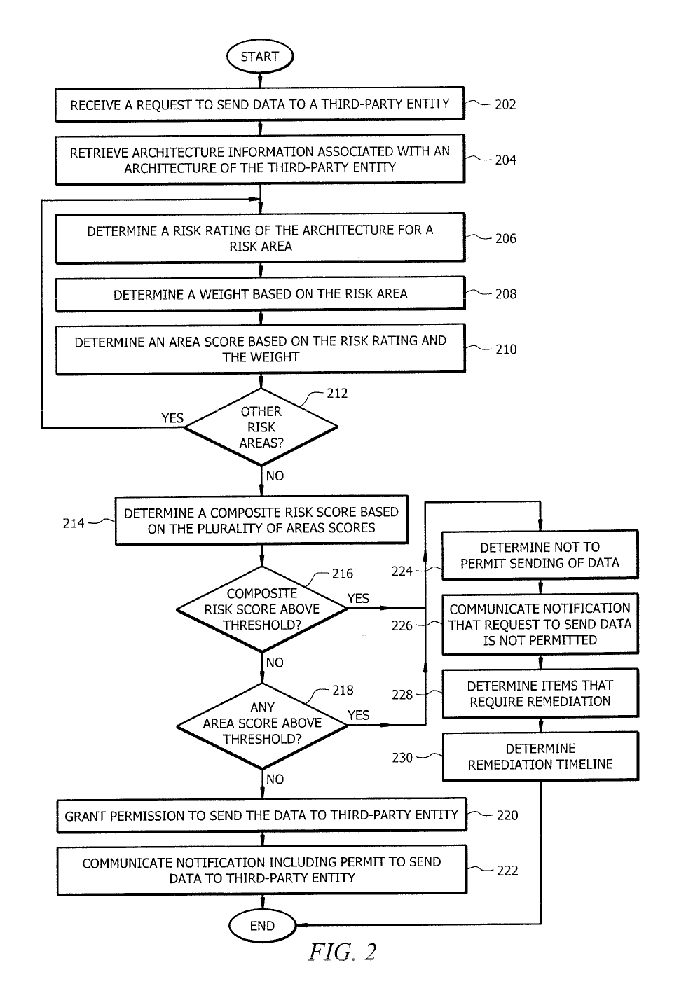

Embodiments of the present invention and its advantages are best understood by referring to FIGS. 1 and 2, like numerals being used for like and corresponding parts of the various drawings.

In the large enterprise environment, the enterprise needs to ensure that their confidential/proprietary data is properly and securely protected internally (i.e., within the physical and network confines of the enterprise), and also the enterprise must ensure that confidential/proprietary data is properly secured by external entities that receive the data from the enterprise. In the financial institution setting, external entities may include vendors (i.e., entities in a contractual relationship with the financial institution) and other non-contracting third-party entities, for example, other financial institutions. The financial institution must ensure that the external entity has the proper mechanisms, procedures, and governance in place to receive confidential/proprietary data, and also properly store such data to prevent exposure. Moreover, in instances where the external entity is implementing the Internet or a mobile platform to host the confidential/proprietary data, the enterprise must ensure that the proper mechanisms, procedures, and governance are in place to securely host the confidential/proprietary data. In this regard, the enterprise must be able to manage the risk surrounding the use of the confidential/proprietary data by an external entity (i.e., outside of the enterprise's firewall).

Current practices within such large enterprises that seek to ensure protection of confidential/proprietary data by external entities tend to be unreliable and inconsistent. In this regard, assessments of external entities by the enterprise tend to occur sporadically or reactively (i.e., in response to a compromise of the data at the external entity). Moreover, proper procedures may not be in place at the enterprise to ensure that consistent review and approval of external entities occurs.

The current disclosure recognizes the needs for a technical architecture assessment of the architecture of third-party entities to ensure security of confidential/proprietary data. The current disclosure includes retrieving architecture information from a third-party entity regarding its architecture and performing a technical architecture assessment. This assessment analyzes the risk of a security breach involved in transferring and/or storing confidential/proprietary data to a third-party entity. If the risk of any data breach or issue is sufficiently low, the assessment determines that the confidential/proprietary data may be transferred and/or stored within the third-party entity. This assessment may be initiated prior to any new contracts being created with a third-party entity and before any existing contracts are materially changed or renewed with third-party entities, particularly where the third-party entities require the enterprise to send confidential data outside the firewalls of the enterprise. This assessment brings more visibility and control to the risks associated with customer confidential data leaving the enterprise.

FIG. 1 illustrates a system 100 that facilitates technical architecture assessment. System 100 may include enterprise 110, administrator workstation 150, one or more data sources 160, one or more third-party entities 130, and one or more Technical Architecture Assessment Modules (TAAM) 140. Enterprise 110, administrator workstation 150, third-party entity 130, and TAAM 140 may be communicatively coupled by network 120.

In general, TAAM 140 facilitates the assessment of various criteria related to the architecture of third-party entity 130. TAAM 140 receives a request to transfer data from data source 160 to third-party entity 130 and retrieves the architecture information 131 associated with an architecture of third-party entity 130. TAAM 140 determines a risk rating of the architecture for at least one of a plurality of risk areas, determines a weight based on the at least one of the plurality of risk areas, and determines an area score based on the risk rating and the weight. TAAM 140 also determines whether to grant permission to send the data from data source 160 to third-party entity 130 based at least in part on the area score.

Network 120 may refer to any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof. Network 120 may communicatively couple third-party entity 130 with enterprise 110.

In some embodiments, administrator workstation 150 may refer to any device that facilitates administrator 151 performing a function in or interacting with system 100. In some embodiments, administrator workstation 150 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100.

In some embodiments, administrator workstation 150 may also comprise a graphical user interface (GUI) 152. GUI 152 is generally operable to tailor and filter data entered by and presented to administrator 151. GUI 152 may comprise a plurality of displays having interactive fields, pull-down lists, and buttons operated by administrator 151. GUI 152 may include multiple levels of abstraction including groupings and boundaries. It should be understood that the term GUI 152 may be used in the singular or in the plural to describe one or more GUIs 152 and each of the displays of a particular GUI 152. It will be understood that system 100 may comprise any number and combination of administrator workstations 150. Administrator 151 utilizes administrator workstation 150 to interact with TAAM 140 to input architecture information of third-party entity 130 and/or receive visualization of data, as described below.

Data sources 160 may refer to any module, database, or suitable storage device to store information for enterprise 110. Data sources 160 may include any number of files, folders, and pieces of data. For example, data source 160 may store confidential customer information, such as a customer's name, address, social security number, and financial information. Data from data sources 160 may be transferred to components within enterprise 110 or outside enterprise 110 (e.g., to third-party entity 130) via network 120 or any other suitable means.

Third-party entity 130 may refer to any entity that is not associated with and is remote to enterprise 110. Third-party entities 130 are typically associated with a third-party service that provides a service to enterprise 110, administrator 151, and/or customers of enterprise 110. For example, third-party entity 130 may be a vendor that receives credit applications for customers of enterprise 110 (e.g., a bank). For each customer, third-party entity 130 (e.g., a vendor) may retrieve credit bureau information and provide information to enterprise 110 to make credit decisions. Third-party entity 130 may comprise an architecture, for example, the architecture that data is stored on within third-party entity 130. Third-party entity 130 may comprise architecture information 131 corresponding to its architecture. Architecture information 131 may correspond to the assessments associated with each of the plurality of risk areas. For example, architecture information 131 may include information relating to the data store risk area, such as what data protection controls (e.g., encryption and masking) are used in applications of third-party entity 130. The assessments column in Table 1 below includes examples of the types of information that architecture information 131 may include.

TAAM 140 may refer to any suitable combination of hardware and/or software implemented in one or more modules to process data and provide the described functions and operations. In some embodiments, the functions and operations described herein may be performed by a pool of TAAMs 140. In some embodiments, TAAM 140 may include, for example, a mainframe, server, host computer, workstation, web server, file server, a personal computer such as a laptop, or any other suitable device operable to process data. In some embodiments, TAAM 140 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, TAAM 140 retrieves architecture information from third-party entity 130 to determine risk associated with transferring data to third-party entity 130 and to determine whether to grant permission to send the data of data source 160 to third-party entity. Although shown in FIG. 1 as internal to enterprise 110, it should be understood that TAAM 140 may be internal or external to enterprise 110. In some embodiments, TAAM 140 may include processor 155, memory 160, and interface 165.

Memory 160 may refer to any suitable device capable of storing and facilitating retrieval of data and/or instructions. Examples of memory 160 include computer memory (for example, RAM or ROM), mass storage media (for example, a hard disk), removable storage media (for example, a CD or a DVD), database and/or network storage (for example, a server), and/or or any other volatile or non-volatile, non-transitory computer-readable memory devices that store one or more files, lists, tables, or other arrangements of information. Although FIG. 1 illustrates memory 160 as internal to TAAM 140, it should be understood that memory 160 may be internal or external to TAAM 140, depending on particular implementations. Also, memory 160 may be separate from or integral to other memory devices to achieve any suitable arrangement of memory devices for use in system 100.

Memory 160 is generally operable to store logic 162, rules 164, risk areas 167, and weights 168. Logic 162 generally refers to algorithms, code, tables, and/or other suitable instructions for performing the described functions and operations. Rules 164 generally refer to policies or directions for determining the risk associated with transferring data to third-party entity 130 and to determine whether to grant permission to send the data of data source 160 to third-party entity. Rules 164 may be predetermined or predefined, but may also be updated or amended based on the needs of enterprise 110. Risk areas 167 may refer to categories or information to be retrieved from third-party entity 130 about the architecture of third-party entity 130 in order to assess risk. Risk areas 167 may refer to any characteristic, quality, feature, or property that may apply to the architecture of third-party entity 130. Memory 160 stores these risk areas 167 so that TAAM 140 may retrieve all necessary architecture information to perform its analysis, as described below. Memory 160 also stores one or more weights 168 associated with each risk area 167, as described below.

In some embodiments, TAAM 140 stores a plurality of risk areas 167 in memory 160 to facilitate technical architecture assessment. As an example, Table 1 shows example risk areas 167 and the aspects of the architecture that are assessed within each risk area.

TABLE 1
Example Risk Areas and Assessments/Attributes

| Risk Area | Assessments/Attributes |
|---|---|
| Authentication | Access, entitlement, and authorization controls |
| and | Usage of insecure protocols |
| Authorization | Policy enforcement for access control |
| Processes | Session and credential management processes |
| | Cryptographic key management processes |
| Data storage | Data protection controls (encryption, masking) in third- |
| | party entity hosted applications |
| | Data integrity measures like hashing and digital |
| | signatures |
| | Data retention/archival processes across third-party |
| | entity environments hosting our data (Production, DR, |
| | test, etc.) |
| | Controls to mitigate Cloud computing/Shared hosting |
| | related risks to enterprise data |
| Data transfer | Risks associated with protocols used to transfer data |
| and Custody | between the enterprise and the third-party entity |
| | Usage of PKI, digital certificates, tokens etc. relevant |
| | to data transfer |
| End-to-End | Overall risk with third-party entity's end-end |
| Application | application architectures - components, interactions, |
| Architecture | data flows, APIs, systems and technologies |
| | Appropriate hardening and security of applications |
| | storing or processing enterprise data |
| | Software and hardware stack vulnerabilities |
| | Third-party entity SDLC process related risks |
| Employee/ | Employee/Subcontractor Access Management |
| Contractor | (Appropriate controls on VPN technologies, data |
| Access to | access) |
| Application | Third-party entity controls against insider threats |
| Security Event | Application, Database, System, Network, and Device |
| Logging and | Logging |
| Monitoring | Sensitive Data exposure and its lineage |
| | Policies and controls for access to logs, retention of |
| | logs |
| | Monitoring of user access to enterprise data |

The assessments column in Table 1 includes the type of information that is being analyzed to determine a risk rating of the architecture of third-party entity 130, as described below. In some embodiments, these categories of information may be included in architecture information 131 of third-party entity 130. In some embodiments, weights may be standardized based on the industry, types of breaches, statistical analysis, frequency of occurrence, and/or any condition making a risk area more or less serious. In some embodiments, weights may be customizable and determined by TAAM 140 on a regularly interval (e.g., weekly, monthly, yearly). Weights 168 may be stored in memory 165 such that TAAM 140 may have access to the most recently determined weight values.

Memory 160 communicatively couples to processor 155. Processor 155 is generally operable to execute logic 162 stored in memory 160 to determine whether to grant permission to send the data of data source 160 to third-party entity 130, according to the disclosure. Processor 155 may comprise any suitable combination of hardware and software implemented in one or more modules to execute instructions and manipulate data to perform the described functions for TAAM 140. In some embodiments, processor 155 may include, for example, one or more computers, one or more central processing units (CPUs), one or more microprocessors, one or more applications, and/or other logic.

In some embodiments, communication interface 165 (I/F) is communicatively coupled to processor 155 and may refer to any suitable device operable to receive input for TAAM 140, send output from TAAM 140, perform suitable processing of the input or output or both, communicate to other devices, or any combination of the preceding. Communication interface 165 may include appropriate hardware (e.g., modem, network interface card, etc.) and software, including protocol conversion and data processing capabilities, to communicate through network 120 or other communication system that allows TAAM 140 to communicate to other devices. Communication interface 165 may include any suitable software operable to access data from various devices such as administrator workstation 150 and/or application modules 130. Communication interface 165 may also include any suitable software operable to transmit data to various devices such as administrator workstation 150. Communication interface 165 may include one or more ports, conversion software, or both. In general, communication interface 165 may retrieve architecture information 131 from third-party entity 130 and may send information to administrator workstation 150, such as calculated area scores, remediation requirements for third-party entity 130, and a permit to send the data of data source 160 to third-party entity 130.

In operation, logic 162 and rules 164, upon execution by processor 155, facilitate determining a risk rating of the architecture of third-party entity 130, determining a weight based on a risk area, determining an area score based on the risk rating and the weight, and determining whether to grant permission to send data of data source 160 to third-party entity 130. Logic 162 and rules 164 also facilitate determining items of the architecture of third-party entity 130 that require remediation before granting permission to send the data, determining a composite risk score based on a plurality of area scores, and comparing the area score to a threshold to determine whether to grant permission to send the data to third-party entity 130.

In some embodiments, TAAM 140 receives a request to send data to third-party entity 130. Data of data source 160 may include confidential customer information that needs to be sent to third-party entity 130. For example, third-party entity 130 may be a vendor that receives credit applications for customers of enterprise 110 to make credit decisions. Another component of enterprise 110 may transmit a request to TAAM 140 to send confidential customer data (e.g., name, address, social security number of customers). In some embodiments, the request to send data may correspond to a request to execute a contract or statement-of-work (SOW), modify a contract, or renew a contract with a vendor that may be receiving confidential data of enterprise 110 on a regular basis. TAAM 140 assesses the architecture of third-party entity 130 (i.e., before a contract is executed) to determine whether the architecture of third-party entity 130 is sufficient to receive and store such confidential data.

In some embodiments, TAAM 140 retrieves architecture information 131 associated with an architecture of the third-party entity, the architecture information corresponding to at least one of the plurality of risk areas. Architecture information 131 may include artifacts, technical diagrams, information regarding encryption, or any other documentation that provides information regarding the architecture of third-party entity 130. TAAM 140 may retrieve this information from third-party entity 130 at interface 165 via network 120.

In some embodiments, TAAM 140 determines a risk rating of the architecture for at least one of the plurality of risk areas, and the risk rating is based on the architecture information. The risk rating may refer to the probability of a risk of the risk area being realized. The risk rating may include any number of categories and levels of risk. For example, the risk rating may include the categories: Negligible, Low, Medium, High, and Critical. As another example, the risk rating may include various scores increasing with the severity of the risk, such as 25, 50, 75, 100, and 125. The risk ratings depend on various factors, including the impact that an incident would have on enterprise 110 should it occur, enterprise standards, emerging risk in the marketplace, and likelihood of occurrence. In some embodiments, TAAM 140 considers both the technical impact an incident would have on enterprise 110 and/or the business impact an incident would have on enterprise 110. In order to determine a risk rating for each of the plurality of risk areas, TAAM 140 may analyze various factors, such as how difficult vulnerabilities are to discover, the financial impact on revenue of enterprise 110, and potential reputational damage to enterprise 110. Table 2 below illustrates various factors TAAM 140 may consider in order to determine an appropriate risk rating for the risk area that TAAM 140 is assessing.

TABLE 2
Scoring Criteria to Determine Risk Rating

| Risk Rating | Score | Technical Impact | Business Impact |
|---|---|---|---|
| Negligible | 25 | Practically impossible to discover | Minimal financial impact to |
| | | vulnerabilities, relatively unknown and | organization to remedy |
| | | extremely difficult to exploit threats requiring | Negligible reputational |
| | | highly skilled agents | damage |
| | | Minimal non-sensitive data disclosed | Little to no non-compliance |
| | | Minimal data corruption | exposure |
| | | Minimal disruption to non-mission critical | No PII data exposure |
| | | services | |
| | | Complete traceability of responsible systems, | |
| | | accounts or users in case of breach | |
| Low | 50 | Difficult to discover, hidden and difficult to | Low financial impact on |
| | | exploit threats that require advanced users | bank's revenue or profitability |
| | | and/or sophisticated malicious agents | (isolated and localized to Line |
| | | Minimal business critical and/or sensitive data | of Business (LOB)) |
| | | compromised or disclosed | Minor potential reputational |
| | | Serious but locally contained data corruption | damage (loss of customers, |
| | | Minimal disruption to mission critical | accounts, or goodwill) |
| | | services, usually localized | Some non-compliance |
| | | Moderate traceability of responsible systems, | exposure |
| | | accounts or users in case of breach | Small amount of personally |
| | | | identifiable information (PII) |
| | | | data exposure for few |
| | | | individual, employee or |
| | | | business customers (100s of |
| | | | records) |
| Medium | 75 | Moderately difficult to discover, somewhat | Moderate financial impact on |
| | | known and moderately difficult to exploit | bank's revenue or profitability |
| | | threats that require skilled agents | (multiple LOBs or regions) |
| | | Reasonable extent of business critical, | Major potential reputational |
| | | confidential, and/or sensitive data | damage (loss of customers, |
| | | compromised or disclosed | accounts, or goodwill) |
| | | Serious and business unit or LOB wide data | Moderate non-compliance |
| | | corruption | exposure (with risks of |
| | | Moderate disruption to enterprise wide | external fines, lawsuits etc.) |
| | | mission critical services | Moderate amount of PII data |
| | | Low traceability of responsible systems, | exposure for individual, |
| | | accounts or users in case of breach | employee or business |
| | | | customers (1000s of records) |
| High | 100 | Easy to discover, fairly well known and easy | High financial impact on |
| | | to exploit threats that require no special skills, | bank's revenue or profitability |
| | | code is available readily for exploits | (enterprise wide) |
| | | Extensive business critical, confidential, | High potential reputational |
| | | and/or sensitive data compromised or | damage (loss of customers, |
| | | disclosed | accounts, or goodwill) |
| | | Extensive data corruption regions or multiple | High non-compliance |
| | | LOBs | exposure (with risks of heavy |
| | | Large disruptions to enterprise wide mission | fines, additional scrutiny, |
| | | critical services as well as non-essential | lawsuits etc.) |
| | | services | Large extent of PII data |
| | | Low traceability of responsible systems, | exposure for most individual, |
| | | accounts or users in case of breach | employee or business |
| | | | customers (10s of thousands |
| | | | of records) |
| Critical | 125 | Easy to discover, publicly known and trivially | Extensive financial impact on |
| | | easy to exploit threats that require don't | bank's revenue or profitability |
| | | require skilled agents | (enterprise wide) |
| | | Extensive business critical, confidential, | Extensive reputational |
| | | and/or sensitive data compromised or | damage (loss of customers, |
| | | disclosed | accounts, or goodwill), |
| | | Enterprise wide data corruption that can halt | extensive potential damage to |
| | | or negatively operations across enterprise | brand image |
| | | Large disruptions to enterprise wide mission | Global non-compliance |
| | | critical services as well as non-essential | exposure (with risks of heavy |
| | | services | fines, additional scrutiny, |
| | | Completely anonymous with little to no | lawsuits etc.) |
| | | traceability of responsible systems, accounts | Extensive PII data exposure |
| | | or users in case of breach | for all individual, employee or |
| | | | business customers (millions |
| | | | of records to entire dataset) |

In some embodiments, TAAM 140 may determine two risk ratings: one relating to the technical impact and one relating to the business impact. TAAM 140 may determine a final risk rating by combining the technical risk rating and the business risk rating. For example, if the technical risk rating is low and the business risk rating is high, TAAM 140 may determine the risk rating for that risk area medium (i.e., averaging the two risk ratings). As another example, TAAM 140 may determine the risk rating to be the worst case (maximum) risk rating across the business risk rating and technical risk rating. Thus, if the business risk rating is negligible and the technical risk rating is high, then the overall risk rating for the risk area would be high.

In some embodiments, TAAM 140 determines a weight based on the at least one of the plurality of risk areas. Memory 160 may store weights 168 that correspond to the plurality of risk areas. For example, as shown in Table 3 below, each risk area may have certain corresponding weights. These weights may be determined to reflect the current risk potential across the third-party entity landscape. TAAM 140 may change these weights as the technologies of third-party entity 130 evolve and the risk posture of enterprise 110 changes. Further, weights may be subject to annual review and refinement based on current business conditions and third-party entity landscape.

TABLE 3
Risk Areas and Corresponding Weights

| Risk Area | Weights (%) |
|---|---|
| Authentication and Authorization | 20% |
| Processes | |
| Data storage | 20% |
| Data transfer and Custody | 15% |
| End-to-End Application Architecture | 25% |
| Employee/Contractor Access to | 10% |
| Application | |
| Security Event Logging and | 10% |
| Monitoring | |

In some embodiments, TAAM 140 determines an area score based on the risk rating and the weight. The risk rating and the weight may be multiplied together to determine the area score in some embodiments. For example, if the risk rating is low (corresponding to a value of 50) and the weight is 20%, then the area score would be 50 times 0.20, which is 10. As another example, if the risk rating is high (corresponding to a value of 100) and the weight is 30%, then the area score would be 100 times 0.30, which is 30. The values corresponding to each risk rating may be any suitable value that portrays the seriousness of the risks at issue. Risk rating and the weights may be combined in any manner to allow TAAM 140 to determine an area score. Example risk ratings, weights, and area scores according to certain embodiments are illustrated below in Table 4.

In some embodiments, TAAM 140 determines whether to grant permission to send the data to third-party entity 130 based at least in part on the area score. TAAM 140 may compare the area score to one or more thresholds. For example, if the area score is greater than 40, then TAAM 140 may deny permission to send the data to third-party entity 130. In some embodiments, TAAM 140 may analyze the risk rating that contributed to the area score to determine whether to grant permission. For example, if any of the risk ratings are “critical,” TAAM 140 may deny permission.

TABLE 4
Example Architecture Risk Ratings and Scores

| Risk Area | Risk Rating | Weight | Area Score |
|---|---|---|---|
| Authentication and | Low | 20% | 10 |
| Authorization | | | |
| Processes | | | |
| Data storage | Medium | 20% | 15 |
| Data Transfer and | Low | 15% | 7.5 |
| Custody | | | |
| End-to-End | Low | 25% | 12.5 |
| Application | | | |
| Architecture | | | |
| Employee/Contractor | Medium | 10% | 7.5 |
| Access to | | | |
| Application | | | |
| Security Event | Low | 10% | 5 |
| Logging and | | | |
| Monitoring | | | |
| Composite Risk | | 100% | 57.5 |
| Score | | | |

In some embodiments, TAAM 140 determines a composite risk score based on a plurality of area scores. The composite risk score reflects the total score for the architecture associated with third-party entity 130, including aspects from every risk area. TAAM 140 may use one, some, or all of the area scores to determine the composite risk score. As shown in the example illustrated in Table 4 above, TAAM 140 may sum the area scores for each risk area to determine a composite risk score. TAAM 140, in some embodiments, may determine whether to grant permission to send the data to third-party entity 130 based at least in part on the composite risk score. For example, TAAM 140 may compare the composite risk score to one or more thresholds. If the composite risk score of 57.5 as illustrated in Table 4 is compared to the threshold of 60, then TAAM 140 may determine to grant permission to send the data to third-party entity 130 because the composite risk score is less than the threshold.

In some embodiments, TAAM 140 communicates a notification, which includes a permit to send the data to third-party entity 130. Interface 165 of TAAM 140 may communicate the notification to the component or module of enterprise 110 that originally requested that the data be sent (e.g., administrator 151 or a separate module). This notification may initial the process of sending the confidential data to third-party entity 130, in some embodiments.

In some embodiments, TAAM 140 determines items of the architecture that require remediation before granting permission to send the data to third-party entity 130. TAAM 140 may determine that items of the architecture require remediation by identifying a critical (e.g., clear and present) vulnerability in any of the risk areas. By identifying these vulnerabilities, TAAM 140 provides an opportunity for third-party entity 130 to remediate the vulnerabilities before a final recommendation is made regarding granting or denying permission to send the data to third-party entity 130.

A component of system 100 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to the systems described herein without departing from the scope of the invention. For example, system 100 may include any number of third-party entities 130, data sources 160, networks 120, administrator workstations 150, and TAAMs 140. As another example, particular functions, such as calculating area scores may be performed by a separate component and TAAM 140 receives the information regarding the area scores. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set.

FIG. 2 illustrates an example flowchart for facilitating technical architecture assessment. The method begins at step 202 where, in some embodiments, TAAM 140 receives a request to send data of data sources 160 to third-party entity 130. In some embodiments, another component of enterprise 110 will send a request so that TAAM 140 may first determine whether the architecture associated with third party entity 130 is sufficient before the component may transfer the necessary data. For example, enterprise 110 may need to send data associated with data source 160 to third-party entity 130 in order to provide certain services to customers of enterprise 110. For example, enterprise 110 may need to send confidential customer data such as social security numbers, names, addresses, and phone numbers to third-party entity 130 so that third-party entity 130 may provide feedback to enterprise 110. Continuing the example, third party entity 130 may be a vendor to determine whether to offer a credit card to a customer of enterprise 110. TAAM 140 may receive the request at interface 165 via network 120 from another component in enterprise 110.

At step 204, in some embodiments, TAAM 140 retrieves architecture information 131 associated with an architecture of third-party entity 130. In some embodiments, TAAM 140 may receive architecture information 131 at interface 165 via network 120. For example, architecture information 131 may be electronic data corresponding to architecture of third-party entity 130 such as artifacts, databases, and information about authentication. In some embodiments, TAAM 140 may receive architecture information 131 from administrator 151 via network 120. For example, administrator 151 may receive information about the architecture of third-party entity 130 in the form of a questionnaire or survey and then input the appropriate architecture information 131 into TAAM 140. For example, third-party entity 130 may send an artifact to administrator 151 showing the bank data storage and custody of the architecture. Administrator 151 may analyze that artifact to determine how the architecture is set up and provide that information to TAAM 140. In some embodiments, architecture information 131 may correspond to a plurality of risk areas such as: (1) Authentication and Authorization Processes; (2) Data storage; (3) Data Transfer and Custody; (4) End-to-End Application Architecture; (5) Employee/Contractor Access to Application; and (6) Security Event Logging and Monitoring. TAAM 140 may analyze architecture information 131 and determine the information that is relevant to each of the plurality of risk areas.

At step 206, in some embodiments, TAAM 140 determines a risk rating of the architecture of third-party entity 130 for a risk area. For example, TAAM 140 may determine a risk rating of medium for the Authentication and Authorization Processes risk area. TAAM 140 may determine the risk rating by analyzing and assessing the attributes associated with this risk area. Some examples of the attributes that TAAM 140 may analyze and assess for the Authentication and Authorization Processes risk are, as well as other risk areas, are shown above in Table 1. For example, in the authentication and authorization processes risk area certain inquiries may include: (1) access entitlement and authorization controls; (2) usage of insecure protocols; (3) policy enforcement for access control; (4) session and credential management processes; and (5) cryptographic key management processes. In some embodiments, each risk area may have its own set of unique assessments/attributes. By assessing these various attributes in the Authentication and Authorization Processes risk area, for example, TAAM 140 may determine the risk rating of medium for this risk area. In some embodiments, the risk rating may be one any of the following levels: negligible, low, medium, high, or critical. In some embodiments, the risk rating may be a numerical value such as 1-5 or 50-125, with the an increased value representing an increased risk and/or severity.

At step 208, in some embodiments, TAAM 140 determines a weight based on the risk area. TAAM 140 may store weights 168 in memory 165. These weights 168 may have been previously determined based on bank and industry standards as well as, a frequency of occurrence in the industry. For example, the weights associated with each risk area may be similar to those shown in Table 3 above. TAAM 140 may determine which risk area it is currently assessing, access a table or database of weights 168 in memory 160, and determine the appropriate weight based on the current risk area. For example, if TAAM 140 is currently assessing the data storage risk area, it may determine the corresponding weight is 20 percent. In some embodiments, TAAM 140 may customize weights 168 depending on the third-party entity 130, the type of data that was requested to be sent in step 202, or any other factor that may impact the severity of risk.

At step 210, in some embodiments, TAAM 140 determines an area score based on risk rating determined in step 206 and the weight determined in step 208. For example, if the End-to-End Application Architecture risk area has a risk rating of low and a weight of 15%, the area score may reflect some combination of these two values. As another example, if the end to end application architecture risk area has a risk rating of one and the weight of 25% area score for end to end application architecture would be 0.25

At step 212, in some embodiments, TAAM 140 determines if there are other risk areas associated with the architecture of third-party entity 130 that have not had an area score determined for them. If TAAM 140 determines that there are other risk areas in step 212, then the method returns to steps 206 through 210 to determine the risk rating, weight, and area score for the relevant risk areas. For example, TAAM 140 may first determine an area score for the authentication and authorization process risk area. After completing steps 206 to steps 210 for this risk area it may repeat these steps for any additional risk areas, such as: Data Storage; Data Transfer and Custody; End-to-End Application Architecture; Employee/Contractor Access to Application; and Security Event Logging and Monitoring. TAAM 140 may repeat steps 206 and 210 for as many risk areas 165 included in memory 160 and/or as many risk areas 165 that are relevant to the architecture of third-party entity 130 that is currently being assessed.

If TAAM 140 determines at step 212 that there no other risk areas for which an area score has not yet been determined, then the method continues to step 214, in some embodiments. At step 214, TAAM 140 determines a composite risk score based on the plurality of area scores determined at step 210. For example, the example illustrated in Table A above shows a composite risk score of 57.5. In this example, TAAM 140 may determine this composite risk score multiplying the weight and the area score for each risk area and then adding each of those scores together. The composite risk score determined at step 214 allows TAAM 140 to incorporate information regarding all the different risk areas into its final determination of whether to grant permission to send the data to third-party entity 130 or not. The composite risk score determined at step 214 may be based on any number of area scores.

At step 216, in some embodiments, TAAM 140 determines whether the composite risk score is above a certain threshold. Continuing the example, the composite risk score of 57.5 from Table 4 may be compared to a threshold of 60. If, at step 216, TAAM 140 determines that the composite risk score is above a threshold the method continues to step 224, which is described below. If TAAM 140 determines that the composite risk score is not above the threshold the method continues to step 218 where TAAM 140 determines whether any area score is above a threshold. For example, TAAM 140 may determine that any risk rating of “critical” may be above the threshold and render the architecture of third-party entity 130 unacceptable. As another example, TAAM 140 may compare at the numerical area score (e.g., a combination of risk rating and weight) to a certain threshold. If at step 218, TAAM 140 determines that the area score is above a certain threshold (e.g., the risk rating is critical and/or the area score is above a threshold of 20), then method continues to step 224, which is described below. If at step 218, TAAM 140 determines that the area score is not above a certain threshold, then the method continues to step 220 and TAAM 140 grants permission to send the data to third-party entity 130. In some embodiments, this permission reflects that TAAM 140 has determined, based on the composite risk of each individual area score, that the architecture associated with third-party entity 130 is sufficiently secure to permit sending confidential data to third-party entity 130.

At step 222, in some embodiments, TAAM 140 communicates a notification, including a permit to send data, to third-party entity 130 and/or the component of enterprise 110 that sent the request in step 202. In some embodiments, this notification and permit automatically initiates the data transfer process. In some embodiments, TAAM 140 communicates this notification and permit to administrator 151 who may initiate the data transfer process after reviewing any aspect of the assessment performed by TAAM 140. This permit may also operate as a standing grant of permission. For example, if enterprise 110 will be sending confidential data to third-party entity 130 on a regular basis (e.g., daily, weekly), this permit allows the data to be transferred automatically rather than TAAM 140 needing to assess the architecture of third-party entity 130 each time any data needs to be sent. In some embodiments, the permit may expire after a certain amount of time (e.g., certain number of years and/or when a contract with third-party entity 130 is up for renewal. After TAAM 140 transmits this notification to any necessary component or party, then the method ends.

If, at step 216 or 218, TAAM 140 determines that either the composite risk score and/or any individual area score is above a certain threshold, then the method continues to step 224 and TAAM 140 determines not to permit the sending of data to third-party entity 130. By comparing the composite risk score and/or area score to thresholds and determining that one or more of these scores are above certain thresholds, TAAM 140 determines that the architecture of third-party entity 130 is not sufficiently secure to receive and/or store confidential data associated with customers of enterprise 110. At step 226, in some embodiments, TAAM 140 communicates a notification that the request to send data is not permitted. TAAM 140 can communicate this notification to a component of enterprise 110 that initially transmitted the request to send data to a third-party entity in step 202. In some embodiments, TAAM 140 communicates this notification to administrator 151 who may, for example, determine that enterprise 110 should not initiate and/or renew a contract with third-party entity 130.

At step 228, in some embodiments, TAAM 140 determines one or more items associated with the architecture of third-party entity 130 that may require remediation. TAAM 140 may review the architecture information retrieved at step 204 to determine the items that require remediation. TAAM 140 may analyze the attributes associated with each risk area and determine which are sufficient or insufficient (e.g., contributed to rejecting the grant of permission to send data). For example, in the Data Storage risk area, TAAM 140 may determine that the data protection controls in the applications hosted by third-party entity 130 are not sufficiently encrypted or masked to enable third-party entity 130 to receive the permit to send data. At step 230, in some embodiments, TAAM 140 may further determine a remediation timeline regarding the items that require remediation that were determined at step 228. For example, under the Application Architecture risk area, TAAM 140 may determine that a certain application version is outdated and thus needs to be upgraded. TAAM 140 may determine a target date (e.g., end of the calendar year) for the upgrade to occur. As another example, TAAM 140 may determine that in order to renew the contract between enterprise 110 and third-party entity 130, the application version must be upgraded. After determining any remediation timeline at step 230, the method ends.

Modifications, additions, or omissions may be made to the methods described herein without departing from the scope of the invention. For example, the steps may be combined, modified, or deleted where appropriate, and additional steps may be added. In an embodiment where TAAM 140 determines that the composite risk score is above a threshold at step 216, TAAM 140 may omit step 218 of determining whether any area score is above a certain threshold. As another example, steps 228 and 230 regarding remediation may be omitted. Additionally, the steps may be performed in any suitable order without departing from the scope of the present disclosure. While discussed as TAAM 140 performing the steps, any suitable component of system 100 may perform one or more steps of the method.

Certain embodiments of the present disclosure may provide one or more technical advantages. In certain embodiments, a system for technical architecture assessment is operable to determine whether a third-party entity has an architecture that provides information security. This reduces or eliminates the risk that confidential customer data is accessed without permission while being sent to and/or stored on an architecture of a third-party entity. In some embodiments, the technical architecture assessment system determines remediation items that, if performed, may result in a grant of permission to send confidential data to a third-party entity. This technique provides alternative solutions to a simple “accept” or “reject” system, thus conserving bandwidth and memory that would be consumed by re-running the architecture assessment each instance a change is made to the architecture of third-party entity.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system for technical architecture assessment, comprising:
a memory operable to store a plurality of risk areas;
an interface operable to:
receive a request to send data to a third-party entity;
retrieve architecture information associated with an architecture of the third-party entity, the architecture information corresponding to at least one of the plurality of risk areas;
a processor communicatively coupled to the memory and the interface, the processor operable to:
determine a risk rating of the architecture for at least one of the plurality of risk areas, the risk rating based on the architecture information;
determine a weight based on the at least one of the plurality of risk areas;
determine an area score based on the risk rating and the weight; and
determine whether to grant permission to send the data to the third-party entity based at least in part on the area score.

2. The system of claim 1, the processor further operable to:
determine a composite risk score based on a plurality of area scores, the plurality of area scores corresponding to the plurality of risk areas; and
determine whether to grant permission to send the data to the third-party entity based at least in part on the composite risk score.

3. The system of claim 1, the interface further operable to communicate a notification, the notification including a permit to send the data to the vendor.

4. The system of claim 1, wherein the area score is based on a technical impact and a business impact.

5. The system of claim 1, wherein the processor is further operable to determine an item of the architecture that requires remediation before granting permission to send the data to the third-party entity.

6. The system of claim 1, the processor further operable to compare the area score to a threshold to determine whether to grant permission to send the data to the third-party entity.

7. The system of claim 1, wherein the risk rating is based on the probability of a risk of the risk area being realized.

8. A non-transitory computer readable storage medium comprising logic, the logic, when executed by a processor, operable to:
store a plurality of risk areas;
receive a request to send data to a third-party entity;
retrieve architecture information associated with an architecture of the third-party entity, the architecture information corresponding to at least one of the plurality of risk areas;
determine a risk rating of the architecture for at least one of the plurality of risk areas, the risk rating based on the architecture information;
determine a weight based on the at least one of the plurality of risk areas;
determine an area score based on the risk rating and the weight; and
determine whether to grant permission to send the data to the third-party entity based at least in part on the area score.

9. The computer readable storage medium of claim 8, the logic further operable to:
determine a composite risk score based on a plurality of area scores, the plurality of area scores corresponding to the plurality of risk areas; and
determine whether to grant permission to send the data to the third-party entity based at least in part on the composite risk score.

10. The computer readable storage medium of claim 8, the logic further operable to communicate a notification, the notification including a permit to send the data to the vendor.

11. The computer readable storage medium of claim 8, wherein the area score is based on a technical impact and a business impact.

12. The computer readable storage medium of claim 8, the logic further operable to determine an item of the architecture that requires remediation before granting permission to send the data to the third-party entity.

13. The computer readable storage medium of claim 8, the logic further operable to compare the area score to a threshold to determine whether to grant permission to send the data to the third-party entity.

14. A technical architecture assessment method, comprising:
storing, in a memory, a plurality of risk areas;
receiving, at an interface, a request to send data to a third-party entity;
retrieving, by the interface, architecture information associated with an architecture of the third-party entity, the architecture information corresponding to at least one of the plurality of risk areas;
determining, by a processor, a risk rating of the architecture for at least one of the plurality of risk areas, the risk rating based on the architecture information;
determining, by the processor, a weight based on the at least one of the plurality of risk areas;
determining, by the processor, an area score based on the risk rating and the weight; and
determining, by the processor, whether to grant permission to send the data to the third-party entity based at least in part on the area score.

15. The method of claim 14, further comprising:
determining, by the processor, a composite risk score based on a plurality of area scores, the plurality of area scores corresponding to the plurality of risk areas; and
determining, by the processor, whether to grant permission to send the data to the third-party entity based at least in part on the composite risk score.

16. The method of claim 14, further comprising communicating, by the interface, a notification, the notification including a permit to send the data to the vendor.

17. The method of claim 14, wherein the area score is based on a technical impact and a business impact.

18. The method of claim 14, further comprising determining, by the processor, an item of the architecture that requires remediation before granting permission to send the data to the third-party entity.

19. The method of claim 14, further comprising comparing the area score to a threshold to determine whether to grant permission to send the data to the third-party entity.

20. The method of claim 14, wherein the risk rating is based on the probability of a risk of the risk area being realized.
